(19) United States
(12) Patent Application Publication
(10) Pub. No.: US 2016/0366638 A1
(43) Pub. Date: Dec. 15, 2016

(54) LTE NETWORK ASSISTED POWER SAVING FOR ACCESS POINTS WITH MULTIPLE CLIENTS

(71) Applicant: QUALCOMM INCORPORATED, SAN DIEGO, CA (US)

(72) Inventor: RAJEEV KUMAR, SAN DIEGO, CA (US)

(21) Appl. No.: 15/248,395

(22) Filed: Aug. 26, 2016

Related U.S. Application Data
(63) Continuation-in-part of application No. 14/696,855, filed on Apr. 27, 2015.

(51) Int. Cl. H04W 52/02; H04W 12/06; H04W 48/06; H04W 48/10

(52) U.S. Cl. CPC H04W 52/0206; H04W 48/10; H04W 12/06; H04W 48/06; H04W 88/06

(57) ABSTRACT

A wireless network includes a base station to transmit and receive cellular signals and an access point to transmit and receive Wi-Fi signals. A system controller is coupled to the base station and the access point. The system controller may receive Wi-Fi signals, via the access point, from a plurality of client devices connected to the wireless network. The system controller may further determine whether each of the plurality of client devices has been idle for at least a threshold duration, and may selectively deactivate the access point based at least in part on the determination. When the access point is deactivated, the system controller may enable each of the plurality of client devices to maintain its connection to the wireless network via the base station.

### CROSS REFERENCE TO RELATED APPLICATIONS

This application is a continuation-in-part of, and claims priority to, co-pending and commonly owned U.S. patent application Ser. No. 14/696,855 entitled “LTE NETWORK ASSISTED POWER SAVING” filed on Apr. 27, 2015, the entirety of which is hereby incorporated by reference.

### TECHNICAL FIELD

The example embodiments relate generally to wireless networks, and specifically to wireless networks including cellular base stations and Wi-Fi access points that share a backhaul connection.

### BACKGROUND OF RELATED ART

Modern wireless communications devices (e.g., mobile phones, tablets, computers, etc.) are often equipped with multiple wireless radios that allow the devices to communicate using various wireless communication standards and protocols. Example wireless communication protocols may include the IEEE 802.11 protocols (e.g., Wi-Fi), Bluetooth protocols according to the Bluetooth Special Interest Group, and Long Term Evolution (LTE). LTE is a set of enhancements to the Universal Mobile Telecommunications System (UMTS) mobile standard promulgated by the Third Generation Partnership Project (3GPP). LTE communications may operate in portions of the licensed frequency spectrum (e.g., between approximately 700 MHz-2.6 GHz; may be known as LTE-L) and may operate in portions of the unlicensed frequency spectrum (e.g., around 5 GHz; may be known as LTE-U).

A client device with a cellular radio is typically connected to a wireless network via a cellular base station. For example, the client device may communicate with the base station using the LTE protocol. In some instances, a client device may also access the wireless network by communicating with a Wi-Fi access point (e.g., using the Wi-Fi protocol) in the wireless network. For example, the base station and the access point (AP) may be connected to the same backhaul network, which may be maintained and/or operated by a carrier or service provider. The backhaul network forms an intermediary connection between wireless sub-networks (e.g., provided by the base station and the AP) and a core network (e.g., the Internet).

It is often desirable to “offload” communications with a client device from a base station to an AP, for example, to reduce the load on the base station. However, maintaining the Wi-Fi radio on the client device in an active state may waste considerable power when no data signals are being communicated over the Wi-Fi link and/or no APs are within wireless range of the client device. For example, while the Wi-Fi radio is active, the client device may continually scan for APs in its vicinity. Similarly, maintaining an AP in an active state may also waste considerable power when no data signals are being communicated over the Wi-Fi link and/or no client devices are within wireless range of the AP. For example, while the AP is active, it may continually broadcast beacon frames.

Thus, it would be desirable to reduce the power consumption of Wi-Fi radios provided in wireless devices.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method and apparatus are disclosed for reducing power consumption in wireless communication devices by selectively disabling Wi-Fi communications between a wireless communications system and one or more client devices. The wireless communications system includes a base station to transmit and receive cellular signals (e.g., based on an LTE standard), and includes an access point to transmit and receive Wi-Fi signals. A system controller is coupled to the base station and the access point. The system controller may receive Wi-Fi signals, via the access point, from a plurality of client devices connected to the wireless network. The system controller may further determine whether each of the plurality of client devices has been idle for at least a threshold duration, and may selectively deactivate the access point based at least in part on the determination. When the access point is deactivated, the system controller may enable each of the plurality of client devices to maintain its connection to the wireless network via the base station.

For example, the system controller may disable the first AP from broadcasting beacons if each of the plurality of client devices has been idle for at least the threshold duration. On the other hand, the system controller may maintain the first AP in an active state if at least one of the plurality of client devices has not been idle for at least the threshold duration. Further, the system controller may trigger deactivation of a Wi-Fi radio in at least one of the plurality of client devices upon determining that the at least one of the plurality of client devices has been idle for at least the threshold duration. For example, the system controller may disable the client device from communicating with, or scanning for, one or more access points.

While the first AP is deactivated, the system controller may receive a cellular signal from at least one of the plurality of client devices. In some aspects, the system controller may then reactivate the first AP in response to the cellular signal, and enable the at least one of the plurality of client devices to communicate with the wireless network via the first AP. In other aspects, the system controller may activate a second AP in response to the cellular signal, and enable the at least one of the plurality of client devices to communicate with the wireless network via the second AP. For example, the system controller may determine that the at least one of the plurality of client devices is closer in proximity to the second AP than to the first AP when the cellular signal is received.

The system controller may enable the at least one of the plurality of client devices to communicate with the wireless network via the second AP by triggering activation of a Wi-Fi radio in the at least one of the plurality of client devices, and enabling the at least one of the plurality of client devices to associate with the second AP using the Wi-Fi radio. In some aspects, the system controller may communicate a network key to the at least one of the plurality of client devices and to the second AP. For example, the network key may be used to authenticate the at least one of the plurality of client devices with the second AP.

### BRIEF DESCRIPTION OF THE DRAWINGS

The example embodiments are illustrated by way of example and are not intended to be limited by the figures of the accompanying drawings. Like numbers reference like elements throughout the drawings and specification.

FIG. 1 shows an example wireless communications system within which the example embodiments may be implemented.

FIGS. 2A and 2B show example timing diagrams depicting selective activation and deactivation of Wi-Fi resources in a wireless network.

FIG. 3 shows an example sequence diagram depicting a backhaul-controlled activation of a Wi-Fi link between a client device and a wireless communications system.

FIG. 4 shows an example wireless communications system including a wireless network comprising multiple access points within which the example embodiments may be implemented.

FIGS. 5A and 5B show example wireless communications systems including wireless sub-networks with multiple access points and multiple client devices.

FIG. 6 shows an example timing diagram depicting selective activation and deactivation of Wi-Fi resources in a wireless network with multiple client devices.

FIG. 7 shows a system controller for a wireless communications system in accordance with example embodiments.

FIG. 8 shows a flowchart depicting an example operation for activating Wi-Fi resources in a wireless network in response to a cellular communications signal.

FIG. 9 shows a flowchart depicting an example operation for controlling an activation and deactivation of Wi-Fi resources in a wireless network.

FIG. 10 shows a flowchart depicting an example operation for selectively deactivating Wi-Fi resources in a wireless network including a plurality of client devices.

FIG. 11 shows a flowchart depicting an example operation for controlling activation and deactivation of a particular Wi-Fi access point.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature and/or details are set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example embodiments are not to be construed as limited to specific examples described herein but rather to include within their scope all embodiments defined by the appended claims.

As used herein, the terms “wireless local area network (WLAN)” and “Wi-Fi” can include communications governed by the IEEE 802.11 standards, Bluetooth®, HiperLan (a set of wireless standards, comparable to the IEEE 802.11 standards, used primarily in Europe), and other technologies used in wireless communications. The term “cellular communications” can include communications governed by the Long-Term Evolution (LTE) standard described by the 3^{rd} Generation Partnership Project (3GPP), the third generation of mobile communications technology (3G) standard, the Global System for Mobile Communications (GSM) standard, and/or other mobile phone standards and/or technologies. In addition, although described herein in terms of exchanging data frames between wireless devices, the example embodiments may be applied to the exchange of any data unit, packet, and/or frame between devices.

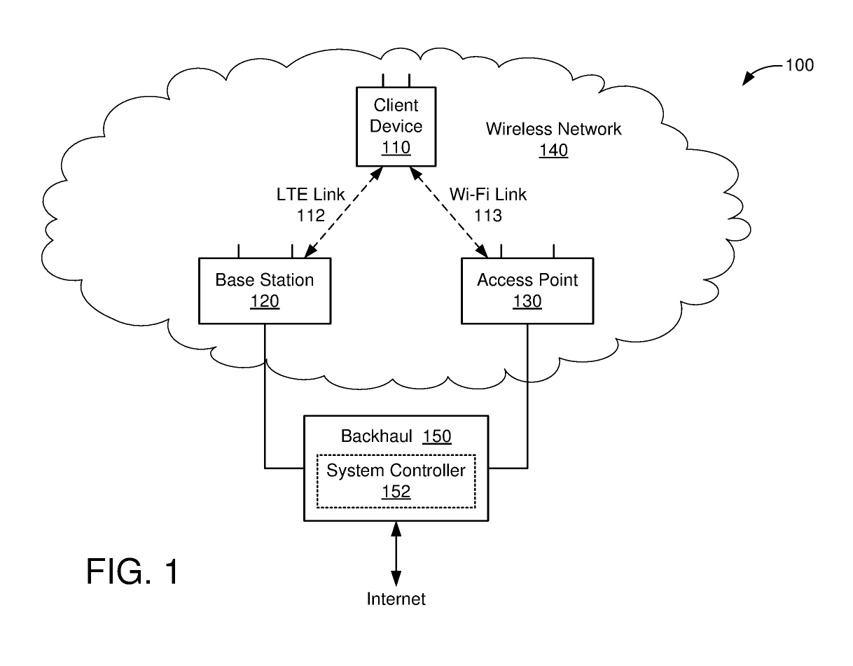

FIG. 1 shows an example wireless communications system 100 within which the example embodiments may be implemented. The system 100 is shown to include a client device 110, a base station 120, and an access point 130. The base station 120 and access point 130 are coupled to a backhaul 150, which serves as an intermediate link to core network resources operated and/or maintained by a carrier or service provider (e.g., the Internet). The backhaul 150 may comprise a network of wired and/or wireless connections. The base station 120 and access point 130 may collectively form a wireless network 140 of the wireless communications system 100, for example, by facilitating wireless communications between the client device 110 and the core network resources (e.g., the Internet). Although only one base station 120 and one access point 130 are shown in FIG. 1, for simplicity, it is to be understood that the wireless network 140 may be formed by any number of base stations (e.g., such as base station 120) and any number of access points (e.g., such as access point 130).

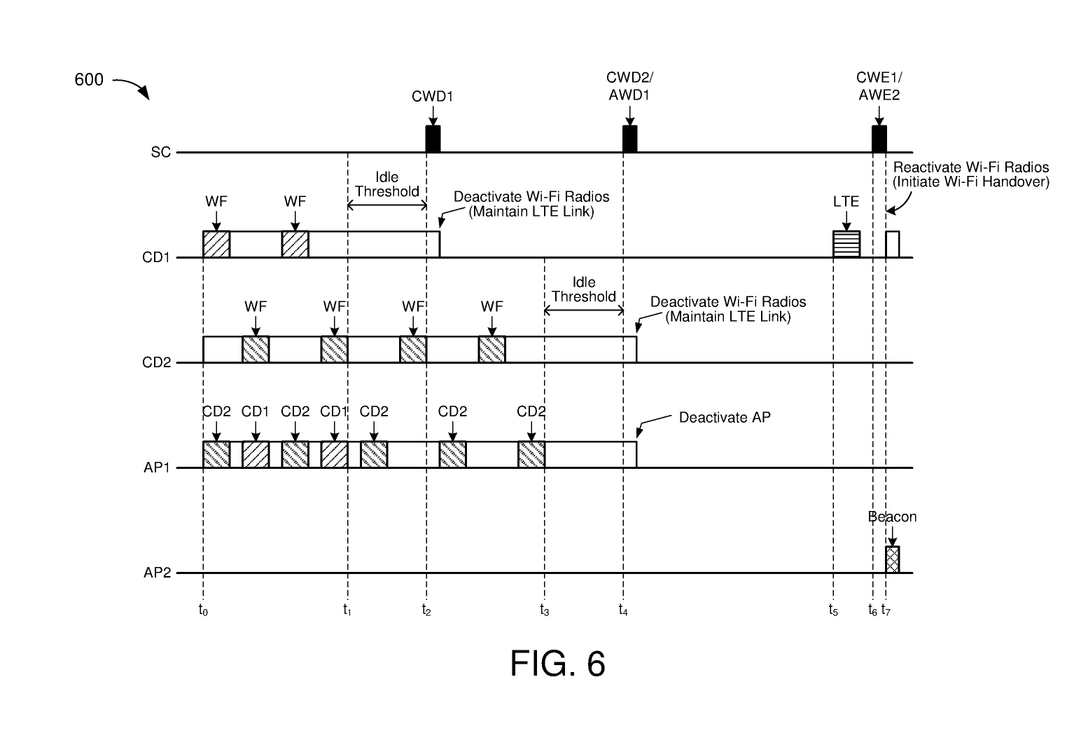

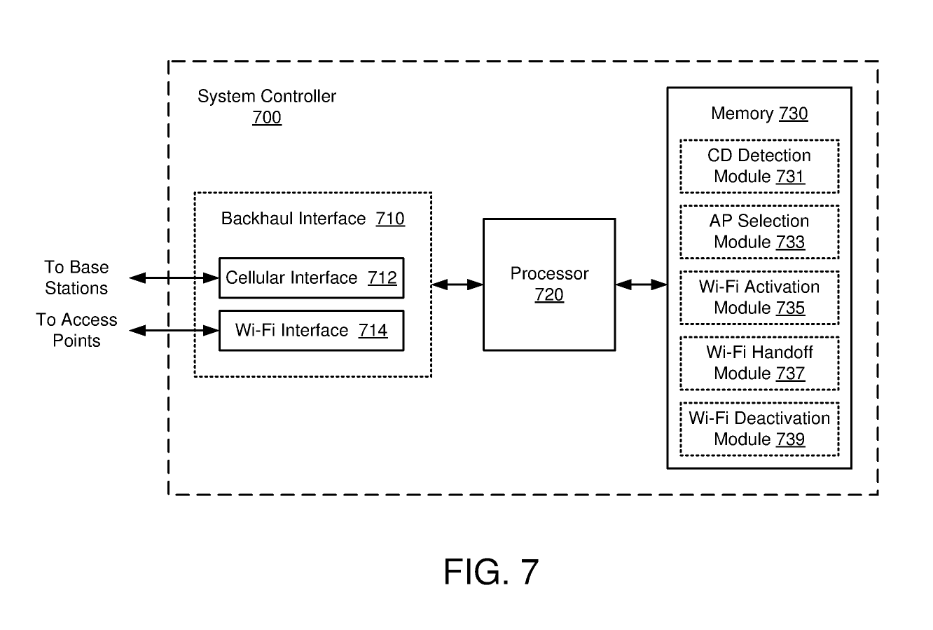

The client device 110 may be any suitable device enabled for wireless communications including, for example, a cell phone, personal digital assistant (PDA), tablet device, laptop computer, or the like. The client device 110 may also be referred to as user equipment (UE), a wireless station (STA), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, the client device 110 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

The base station 120 may be any suitable device that allows one or more wireless devices to connect to a network (e.g., a cellular network, wide area network (WAN), metropolitan area network (MAN), and/or the Internet) via the base station 120 using LTE, 3G, GSM, or any other suitable wireless communication standards. For at least one embodiment, the base station 120 may include one or more transceivers, a network interface, one or more processing resources, and one or more memory resources. The one or more transceivers may include cellular transceivers (e.g., LTE transceivers), and/or other suitable radio frequency (RF) transceivers (not shown for simplicity) to transmit and receive wireless communication signals. Each transceiver may communicate with other wireless devices in distinct operating frequency bands and/or using distinct communication protocols. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

The access point 130 may be any suitable device that allows one or more wireless devices to connect to a network (e.g., a local area network (LAN), WAN, MAN, and/or the Internet) via the access point 130 using Wi-Fi, Bluetooth, or any other suitable wireless communication standards. For some embodiments, the access point 130 may be a software enabled access point (SoftAP) operating on a mobile (e.g., battery-powered) device. Depending on the application, a SoftAP may operate as a conventional access point or as a client device (e.g., such as client device 110). For at least one embodiment, the access point 130 may include one or more transceivers, a network interface, one or more processing resources, and one or more memory resources. The one or more transceivers may include Wi-Fi transceivers, Bluetooth transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6 and 7.

The one or more transceivers of the client device 110, base station 120, and/or access point 130 may include Wi-Fi transceivers, Bluetooth transceivers, cellular transceivers, and/or other suitable radio frequency (RF) transceivers (not shown for simplicity) to transmit and receive wireless communications signals. Each transceiver may communicate with other wireless devices in distinct operating frequency bands and/or using distinct communications protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with the LTE standard (e.g., between 700 MHz and approximately 3.9 GHz) and/or in accordance with other cellular protocols (e.g., 3G, GSM, etc.). In some embodiments, the transceivers included within the client device 110, base station 120, and/or access point 130 may be any technically feasible transceiver such as a ZigBee transceiver described by the ZigBee specification, a Wi-Gig transceiver, and/or a HomePlug transceiver described by a specification from the HomePlug Alliance.

In example embodiments, the Wi-Fi resources (e.g., Wi-Fi radios in the client device 110 and/or access point 130) of the wireless network 140 are deactivated (e.g., to conserve power) when no data signals are being communicated over the wireless medium. For example, deactivating a Wi-Fi resource (e.g., a Wi-Fi radio) may place the resource in a “deep sleep” state, whereby the Wi-Fi resource may be powered on, but prevented from transmitting Wi-Fi signals over the wireless medium. Thus, when the Wi-Fi resource is activated (e.g., returned from the deep sleep state), it may begin transmitting Wi-Fi signals with little or no delay (e.g., since the Wi-Fi resource remains powered on).

For example, the Wi-Fi radio (e.g., including a Wi-Fi transceiver and/or processing resources) on the client device 110 may be deactivated when the client device 110 is not transmitting Wi-Fi data signals to, and/or receiving Wi-Fi data signals from, the access point 130 (e.g., or any other access points in the wireless network 140). When the Wi-Fi radio is deactivated, the client device 110 may be prevented from scanning for nearby access points (e.g., which may unnecessarily drain energy from the client device 110). Similarly, the access point 130 may be deactivated when it is not transmitting Wi-Fi data signals to, and/or receiving Wi-Fi data signals from, the client device 110 (e.g., or any other client devices in the wireless network 140). When the access point 130 is deactivated, it may be prevented from broadcasting beacon frames (e.g., which may unnecessarily drain energy from the access point 130).

The client device 110 may remain connected to the wireless network 140 via an LTE link 112 with the base station 120, regardless of whether the Wi-Fi resources of the wireless network 140 are activated or deactivated. For example, the base station 120 may remain active even if it is not transmitting cellular data signals to, and/or receiving cellular data signals from, the client device 110. Similarly, the cellular radio (e.g., including a cellular transceiver and/or processing resources) on the client device 110 may remain in an active state even if it is not transmitting cellular data signals to, and/or receiving cellular data signals from, the base station 120.

In example embodiments, the Wi-Fi resources of the wireless network 140 may be activated (or reactivated) when the client device 110 initiates a cellular communication with the base station 120. More specifically, activation (and deactivation) of the Wi-Fi resources may be controlled by a system controller 152 coupled to both the base station 120 and the access point 130 (e.g., via the backhaul 150). For example, the client device 110 may transmit an LTE signal (e.g., corresponding to a data frame) to the base station 120. The system controller 152 may detect the LTE frame sent by the client device 110, and trigger activation of the Wi-Fi resources of wireless network 140. For example, in response to detecting the LTE frame, the system controller 152 may restore the Wi-Fi radios (and/or other Wi-Fi resources) of client device 110 and access point 130 to an active state.

For some embodiments, the system controller 152 may facilitate the establishment of a Wi-Fi link 113 between the client device 110 and the access point 130. For example, the system controller 152 may instruct the access point 130 to broadcast beacon frames on a particular channel and/or to use a particular network key. The system controller 152 may also instruct the client device 110 to scan the same channel and/or to use the same network key (e.g., as used by the access point 130) when attempting to connect to the access point 130. After the Wi-Fi link 113 is established, the system controller 152 may hand off any subsequent communications between the client device 110 and the base station 120 to the access point 130.

Handing off wireless communications to the access point 130 may help reduce the load on the base station 120 while continuing to maintain a connection between the client device 110 and the core network of the wireless communications system 100 (e.g., the Internet). Moreover, selectively activating (and deactivating) Wi-Fi resources in an “on-demand” manner (e.g., only when the client device 110 initiates a data communication with the wireless network 140) may help reduce power consumption of the client device 110 and access point 130.

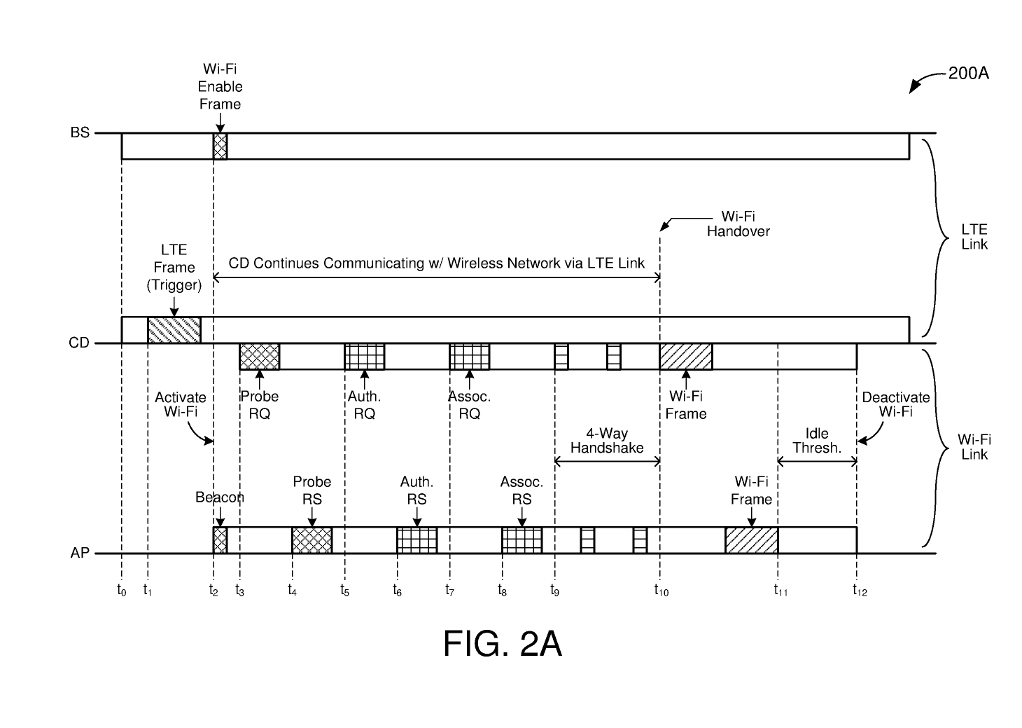

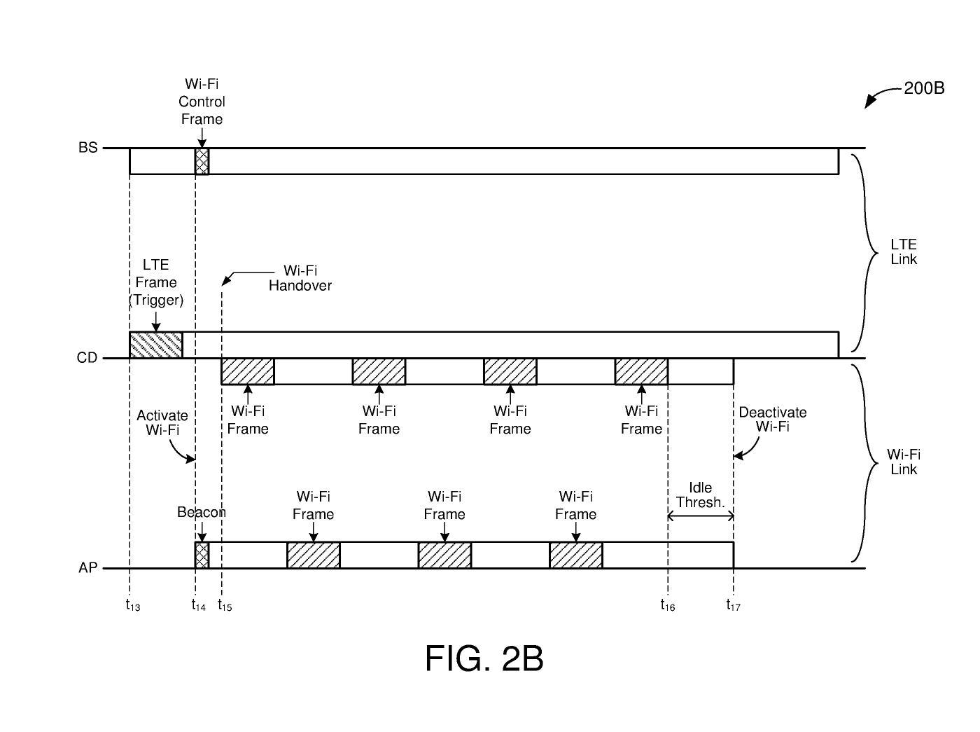

FIGS. 2A and 2B show example timing diagrams 200A and 200B, respectively, depicting selective activation and deactivation of Wi-Fi resources in a wireless network. For purposes of discussion herein, the base station (BS), client device (CD), and access point (AP) may be base station 120, client device 110, and access point 130, respectively, of FIG. 1.

With reference to FIG. 2A, the LTE link 112 between the client device 110 and the base station 120 is initially active, at time t₀, whereas a Wi-Fi link 113 between the client device 110 and the access point 130 has not yet been established. For example, one or more Wi-Fi resources (e.g., Wi-Fi radios) of the client device 110 and/or the access point 130 may be deactivated (e.g., and thus prevented from communicating with one another using Wi-Fi communication protocols). At time t₁, the client device 110 initiates a communication with the wireless network 140 by transmitting an LTE frame to the base station 120 (e.g., via the LTE link 112). In example embodiments, the LTE frame may act as a trigger for activating (e.g., establishing) a Wi-Fi link 113 between the client device 110 and access point 130.

At time t₂, the access point 130 returns (e.g., from a deep sleep state) to an active state and begins broadcasting beacon frames on a Wi-Fi channel. The base station 120 also transmits a Wi-Fi enable frame to the client device 110 (e.g., at time t₂) via the LTE link 112. The Wi-Fi enable frame causes the client device 110 to activate its Wi-Fi radio, at time t₃, and begin broadcasting probe requests (RQ) over a Wi-Fi channel (e.g., to scan for nearby access points). At time t₄, the access point 130 sends a probe response (RS) back to the client device 110 to notify the client device 110 of its Wi-Fi capabilities. For some embodiments, the client device 110 and access point 130 may broadcast their respective management frames (e.g., beacon frames, probe request frames, probe response frames, etc.) over a predetermined Wi-Fi channel.

To establish a Wi-Fi connection between the client device 110 and the access point 130, the client device 110 sends an authentication request to the access point 130 at time t₅, and the access point 130 sends an authentication response back to the client device 110 at time t₆. The exchange of authentication information (e.g., from times t₅ to t₆) may correspond with a low-level authentication process described by the IEEE 802.11 specification. The client device 110 then sends an association request to the access point 130 at time t₇, and the access point 130 sends an association response back to the client device 110 at time t₈. During the association process (e.g., from times t₇ to t₈), the client device 110 and access point 130 negotiate one or more capabilities to be used for subsequent wireless communications with each other. Once associated with one another, the client device 110 and access point 130 may perform a 4-way handshake, from time t₉ to time t₁₀, to complete the connection process. For example, the client device 110 and access point 130 may exchange Extensible Authentication Protocol over LAN (EAPoL) frames with one another to generate a pairwise transient key (PTK) to be used for encrypting (and decrypting) Wi-Fi communications.

While the Wi-Fi link 113 is still being set up (e.g., from times t₂ to t₁₀), the client device 110 may continue communicating with the wireless network 140 via the LTE link 112 (e.g., by exchanging LTE frames with the base station 120). However, after the client device 110 is connected to the access point 130 (e.g., at time t₁₀), the client device 110 may hand off subsequent wireless communications (e.g., intended for the base station 120) to the access point 130. For example, the client device 110 may continue to communicate with the wireless network 140 (e.g., without using the LTE link 112) by exchanging Wi-Fi frames with the access point 130 from time t₁₀ to time t₁₁. For some embodiments, the client device 110 may hand off wireless communications to the access point 130 (e.g., at time t₁₀) only if the quality of the Wi-Fi link 113 is superior to the quality of the LTE link 112 (e.g., greater bandwidth, lower latency, less interference, etc.).

If no activity is detected over the Wi-Fi link 113 for at least a threshold duration (e.g., an “idle threshold”), the client device 110 and access point 130 may subsequently deactivate their respective Wi-Fi resources. For example, at time t₁₂, the idle threshold has been reached (e.g., neither the client device 110 nor the access point 130 has transmitted a Wi-Fi frame over the Wi-Fi link 113 since time t₁₁). Accordingly, the Wi-Fi radios in the client device 110 and/or the access point 130 may return to the deep sleep state (e.g., at time t₁₂). The client device 110 and access point 130 are thus prevented from broadcasting probe requests and beacon frames, respectively (e.g., after time t₁₂). However, the client device 110 may remain actively connected to the wireless network 140 via the LTE link 112 with the base station 120.

In example embodiments, the Wi-Fi link 113 between the client device 110 and access point 130 may be maintained even after it is deactivated (e.g., or rendered inactive). For example embodiments, the client device 110 does not tear down its connection with the access point 130 after the idle threshold has expired (e.g., at time t₁₂). Rather, the client device 110 merely ceases communications (e.g., broadcasting probe requests) over the Wi-Fi link 113. Similarly, the access point 130 does not tear down its connection with the client device 110 after the idle threshold has expired (e.g., at time t₁₂). Rather, the access point 130 also ceases communications (e.g., broadcasting beacons) over the Wi-Fi link 113. This may allow faster handover of communications between the base station 120 and the access point 130 the next time the client device 110 initiates a communication with the wireless network 140.

For example, with reference to FIG. 2B, the client device 110 initiates a subsequent communication with the wireless network 140, at time t₁₃, by transmitting another LTE frame to the base station 120 (e.g., via the LTE link 112). As described above, the LTE link 112 may act as a trigger for reactivating the Wi-Fi link 113 between the client device 110 and access point 130. At time t₁₄, the access point 130 returns (e.g., from the deep sleep state) to an active state and begins broadcasting beacon frames on the Wi-Fi channel. The base station 120 also transmits a Wi-Fi enable frame to the client device 110 (e.g., at time t₁₄) via the LTE link 112. The Wi-Fi enable frame causes the client device 110 to reactivate its Wi-Fi radio at time t₁₅.

Because the Wi-Fi link 113 between the client device 110 and access point 130 was previously established (e.g., at time t₁₀, with reference to FIG. 2A), the client device 110 and access point 130 do not need to repeat the authentication, association, and/or handshake processes (e.g., which took place between times t₅ to t₁₀). Thus, the client device 110 may immediately hand off wireless communications (e.g., intended for the base station 120) to the access point 130 (e.g., at time t₁₅). For some embodiments, the client device 110 may hand off wireless communications to the access point 130 only if the quality of the Wi-Fi link 113 is superior to the quality of the LTE link 112.

At time t₁₇, neither the client device 110 nor the access point 130 has transmitted any Wi-Fi data frames over the Wi-Fi link 113 for at least a threshold duration (e.g., since the last Wi-Fi frame was sent by the client device 110, at time t₁₆). Accordingly, the Wi-Fi radios in the client device 110 and/or access point 130 may return to a deep sleep state (e.g., at time t₁₇). The client device 110 and access point 130 are once again prevented from broadcasting probe requests and beacon frames, respectively (e.g., after time t₁₇). However, the client device 110 remains actively connected to the wireless network 140 via the LTE link 112 with the base station 120.

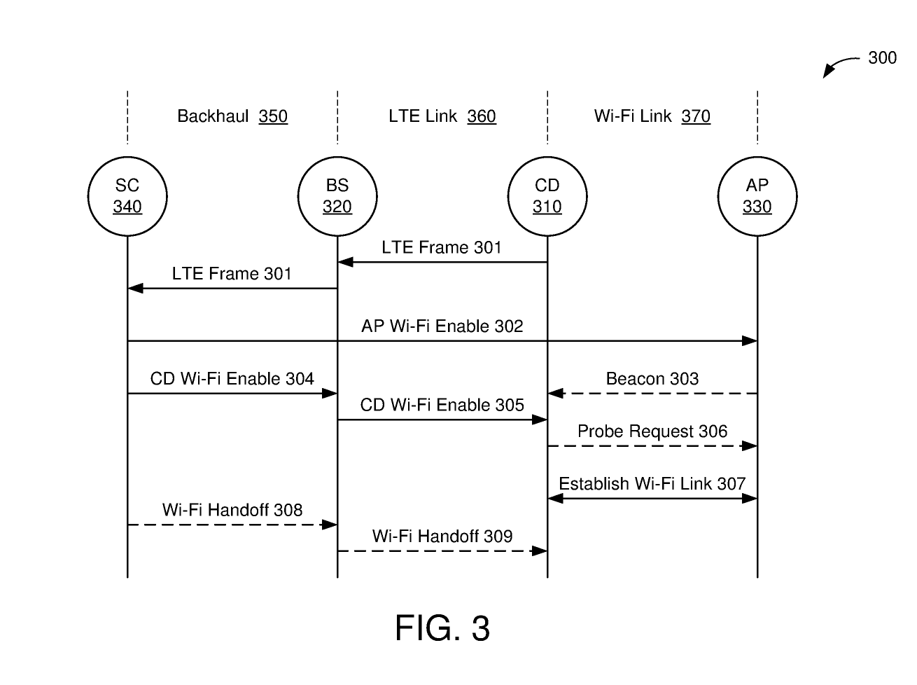

FIG. 3 shows an example sequence diagram 300 depicting a backhaul-controlled activation of a Wi-Fi link between a client device and a wireless communications system. The system controller 340 is coupled to both the base station 320 and the access point 330 via a backhaul connection 350. For some embodiments, the backhaul connection 350 may comprise wired and/or wireless connections. The client device 310 is connected to the base station 320 via an LTE (e.g., cellular) link 360, and may be connected to the access point 330 via a Wi-Fi link 370. In the example of FIG. 3, the LTE link 360 is always active, whereas the Wi-Fi link 370 is initially inactive.

The client device 310 initiates a communication with the base station 320 by sending an LTE frame 301 over the LTE link 360. The base station 320 forwards the LTE frame 301 to the backhaul connection 350, where it is detected by the system controller 340. Upon detecting the LTE frame 301 sent by the client device 310, the system controller 340 sends an AP Wi-Fi enable signal 302 to the access point 330. The AP Wi-Fi enable signal 302 causes the access point 330 to activate one or more of its Wi-Fi resources (e.g., by returning from a deep sleep state) and begin broadcasting beacon frames 303. For some embodiments, the AP Wi-Fi enable signal 302 may include information identifying a predetermined channel (e.g., on which the access point 330 is to broadcast the beacon frames 303) and/or a network key (e.g., used to authenticate client devices requesting to connect to the access point 330).

The system controller 340 also sends a CD Wi-Fi enable signal 304 to the base station 320. The base station 320 transmits the CD Wi-Fi enable signal 304 to the client device 310 (e.g., as a CD Wi-Fi enable frame 305) via the LTE link 360. The CD Wi-Fi enable signal 304 causes the client device 310 to activate one or more of its Wi-Fi resources (e.g., by returning from a deep sleep state) and begin broadcasting probe request frames 306. For some embodiments, the CD Wi-Fi enable frame 305 may include information identifying the predetermined channel on which the access point 330 is to operate (e.g., to broadcast beacon frames 303), and/or may include the network key used by the access point 330 to authenticate client devices.

The client device 310 may identify the access point 330 based on the beacon frames 303 and/or based on probe response frames sent by the access point 330 in response to the probe request frames 306 sent from the client device 310. The client device 310 may then establish a Wi-Fi link 307 with the access point 330, for example, by performing an authentication, association, and handshake operation with the access point 330. Once the client device 310 is connected to the access point 330 via the Wi-Fi link 370, the system controller 340 may selectively enable the base station 320 to hand off subsequent communications with the client device 310 to the access point 330.

In example embodiments, the system controller 340 may allow the client device 310 to continue communicating solely with the base station 320 via LTE link 360 if the performance of the Wi-Fi link 370 is inferior to that of the LTE link 360. For example, the system controller 340 may compare the performance of the LTE link 360 with that of the Wi-Fi link 370 based on communications between the client device 310 and base station 320 or access point 330, respectively. The system controller 340 may then deactivate the Wi-Fi link 370 if it does not offer better performance (e.g., greater bandwidth, lower latency, higher quality of service, less interference, etc.) than the LTE link 360.

In other embodiments, the system controller 340 may send a Wi-Fi handoff signal 308 to the base station 320 if the performance of the Wi-Fi link 370 is superior to that of the LTE link 360 (e.g., offers greater bandwidth, lower latency, higher quality of service, less interference, etc.). The base station 320 may cease communications with the client device 310 upon receiving the Wi-Fi handoff signal 308, and may send a corresponding Wi-Fi handoff frame 309 to the client device 310 (e.g., via the LTE link 360). Upon receiving the Wi-Fi handoff frame 309, the client device 310 ceases communications with the base station 320 and redirects any subsequent and/or ongoing communications to the access point 330 (e.g., via the Wi-Fi link 370).

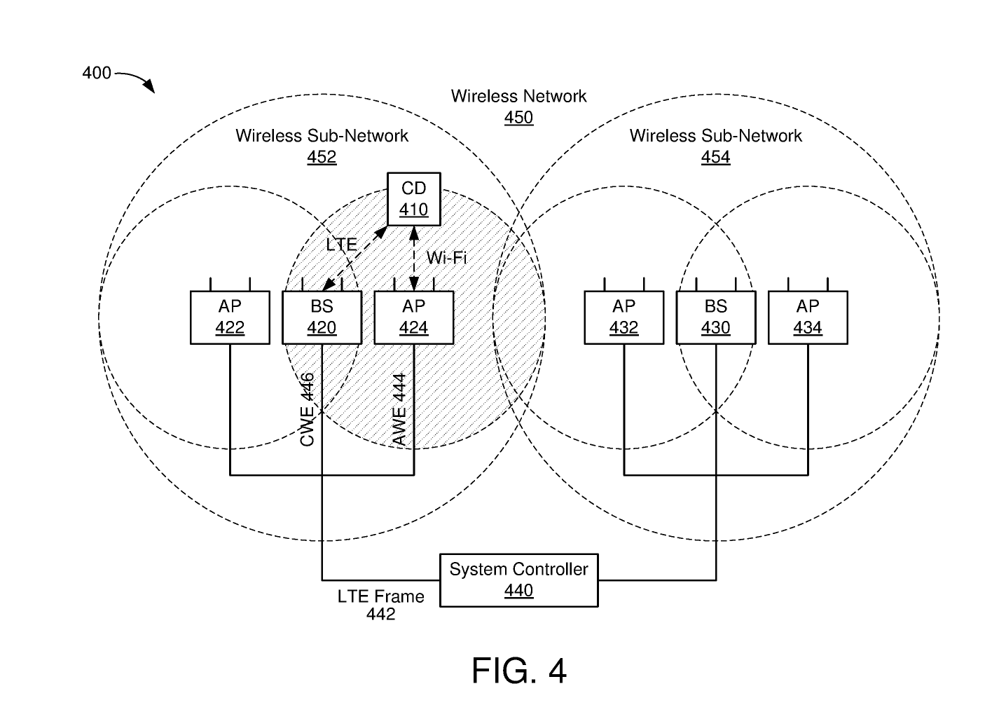

FIG. 4 shows an example wireless communications system 400 including a wireless network 450 comprising multiple access points within which the example embodiments may be implemented. The wireless communications system 400 includes a client device 410, base stations 420 and 430, access points 422, 424, 432, and 434, and a system controller 440. For purposes of discussion herein, the client device 410 and system controller 440 may be embodiments of client device 110 and system controller 152, respectively, of FIG. 1. Each of the base stations 420 and 430 may be an embodiment of base station 120 of FIG. 1, and each of the access points 422, 424, 432, and 434 may be an embodiment of access point 130 of FIG. 1.

The base stations 420 and 430 and access points 422, 424, 432, and 434 collectively form the wireless network 450, and are coupled to the system controller 440 via a backhaul (not shown for simplicity). For example, the client device 410 may access core network resources (e.g., the Internet) by communicating with any of the base stations and/or access points in the wireless network 450. The wireless network 450 may be subdivided into wireless sub-networks 452 and 454. For example, the first wireless sub-network 452 may be provided by base station 420 and access points 422 and 424. The second wireless sub-network 454 may be provided by base station 430 and access points 432 and 434.

In example embodiments, the Wi-Fi resources of the wireless network 450 are deactivated (e.g., prevented from broadcasting beacon and/or probe request frames) as long as no data signals are being communicated over the wireless medium. For simplicity, it may be assumed that the client device 410 is the only client device within wireless range of the wireless network 450. Thus, the access points 422, 424, 432, and 434 may be deactivated (e.g., prevented from broadcasting beacon frames) as long as the client device 410 is idle (e.g., not transmitting and/or receiving data signals via the wireless network 450). Similarly, the Wi-Fi radio of the client device 410 may be deactivated (e.g., prevented from scanning for nearby access points) while the client device 410 is idle.

The client device 410 may remain connected to the wireless network 450 via an LTE (e.g., cellular) link with a nearest base station. In the example shown, the client device 410 is within wireless range of the first wireless sub-network 452, but is outside the range of the second wireless sub-network 454. Thus, the client device 410 may be connected to the wireless network 450 via an LTE link with base station 420. For some embodiments, the base stations 420 and 430 may remain active even if they are not transmitting cellular data signals to, and/or receiving cellular data signals from, the client device 410. Similarly, the cellular radio on the client device 410 may remain in an active state even if it is not transmitting cellular data signals to, and/or receiving cellular data signals from, either of the base stations 420 or 430.

In example embodiments, one or more Wi-Fi resources of the wireless network 450 may be selectively activated (or reactivated) when the client device 410 initiates a cellular communication with the wireless network 450. For example, the client device 410 may transmit an LTE frame 442 to base station 420 via a respective LTE link. The LTE frame 442 is sent by the base station 420 to the system controller 440 (e.g., via the backhaul), which triggers activation of one or more Wi-Fi resources of the wireless network 450. For some embodiments, in response to detecting the LTE frame 442, the system controller 440 may selectively activate one or more of the access points 422, 424, 432, and/or 434 to provide Wi-Fi access for the client device 410. For example, the system controller 440 may select the access point that is closest to and/or provides the greatest Wi-Fi performance for the client device 410.

For some embodiments, the system controller 440 may activate the access point that is closest in proximity to the client device 410. For example, the system controller 440 may determine a location of the client device 410 based on received signal strength indicator (RSSI) values, base station triangulation, global positioning satellite (GPS) data, and/or other geolocation information. The system controller 440 may then determine, based on the location of the client device 410, that access point 424 is closest in proximity to the client device 410. Accordingly, the system controller 440 may send an AP Wi-Fi enable (AWE) signal 444 to access point 424. The AWE signal 444 may be used to activate a particular access point. For example, the AWE signal 444 may include activation instructions that enable the access point 424 to begin broadcasting beacon frames and responding to probe requests.

In an alternative embodiment, the system controller 440 may activate any access points that are within the same wireless sub-network as the client device 410. For example, the system controller 440 may detect that the client device 410 is in the first wireless sub-network 452 because the LTE frame 442 is received by base station 420. Accordingly, the system controller 440 may send the AWE signal 444 to both access points 422 and 424 belonging to the first wireless sub-network 452. As described above, the AWE signal 444 activates the Wi-Fi radios of the access points 422 and 424, for example, so that the access points 422 and 424 may begin broadcasting beacon frames (and respond to probe requests).

The system controller 440 also sends a CD Wi-Fi enable (CWE) signal 446 to the base station 420, which forwards the CWE signal 446 (e.g., as a CWE frame) to the client device 410. The CWE signal 446 may trigger activation of one or more Wi-Fi radios in a particular client device. For example, the CWE signal 446 may include activation instructions that enable the client device 410 to initiate communications with, or scan for, nearby access points (e.g., by broadcasting probe request frames).

For some embodiments, the AWE signal 444 may indicate a predetermined Wi-Fi channel (e.g., on which the access point 424 is to operate) and a network key (e.g., to be used by the access point 424 to authenticate client devices requesting access to the AP 424). Similarly, the CWE signal 446 may also indicate the predetermined Wi-Fi channel (e.g., on which the client device 410 is to scan for the access point 424) and the network key (e.g., to be used by the client device 410 to authenticate with the access point 424).

The system controller 440 may then compare the performance of the Wi-Fi link (e.g., between the client device 410 and the access point 424) with that of the LTE link (e.g., between the client device 410 and the base station 420) to determine which wireless protocol (e.g., LTE or Wi-Fi) offers superior performance (e.g., greater bandwidth, lower latency, higher quality of service, less interference, etc.). If the performance of the LTE link is superior to the performance of the Wi-Fi link, the system controller 440 may allow the client device 410 to continue communicating with the wireless network 450 only through the base station 420 (e.g., and deactivate the access point 424). If the performance of the Wi-Fi link is superior to the performance of the LTE link, the system controller 440 may instruct the base station 420 to hand off subsequent and/or ongoing communications with the client device 410 to the access point 424 (e.g., as described above with reference to FIG. 3).

The wireless communications system 400 has been described above with respect to a single client device 410 for simplicity only. In other embodiments, the wireless communications system 400 may include multiple client devices such as, for example, client device 410. In some aspects, an access point may remain active as long as it continues to serve at least one client device. For example, the system controller may deactivate a particular access point only after all client devices associated with the access point have been idle for at least a threshold duration.

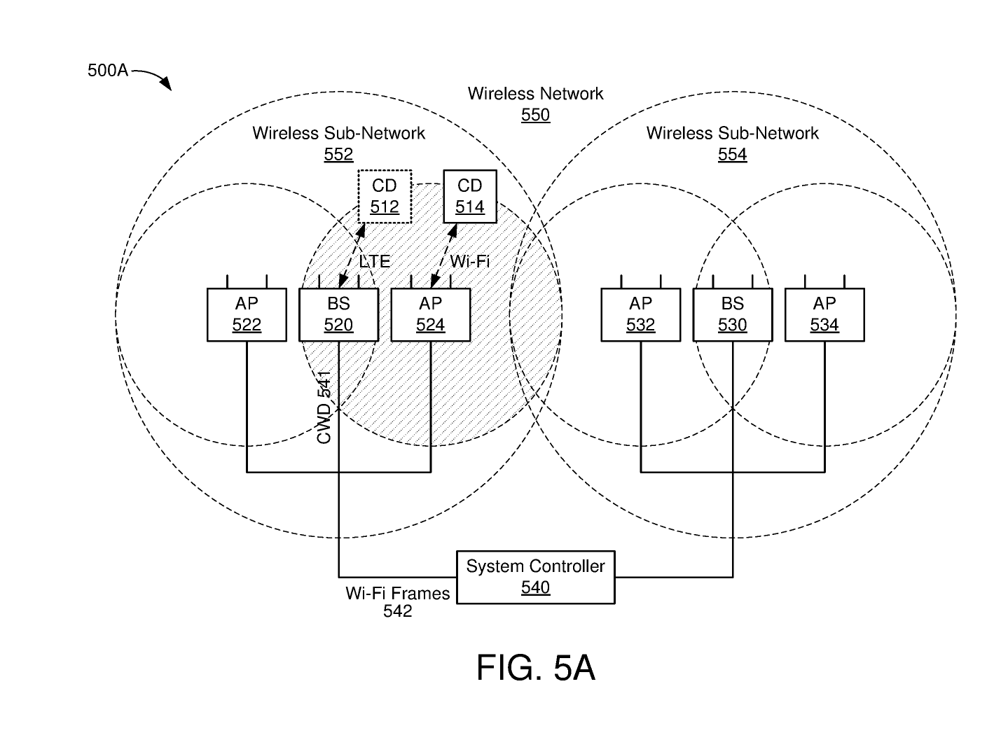

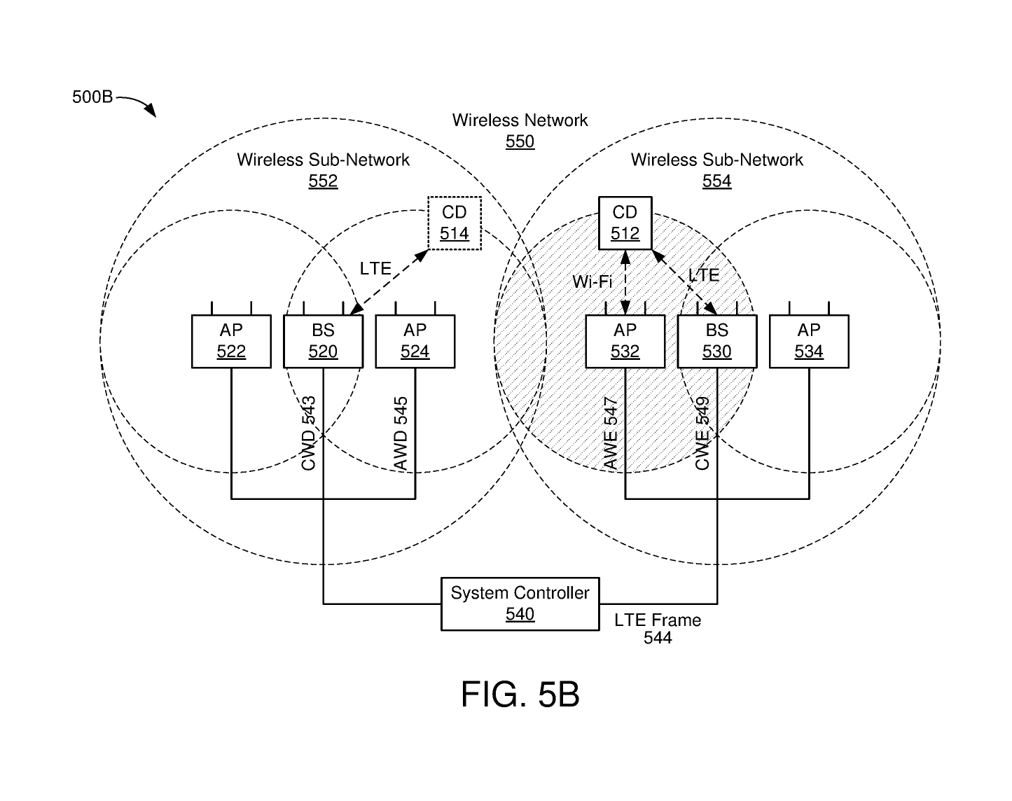

FIG. 5A shows an example wireless communications system 500A including a wireless network 550 with multiple access points and multiple client devices. The wireless communications system 500A includes client devices 512 and 514, base stations 520 and 530, access points 522, 524, 532, and 534, and a system controller 540. For purposes of discussion herein, each of the client devices 512 and 514 may be an embodiment of client device 110 of FIG. 1 and/or client device 410 of FIG. 4. The system controller 540 may be an embodiment of system controller 152 of FIG. 1 and/or system controller 440 of FIG. 4. Each of the base stations 520 and 530 may be an embodiment of base station 120 of FIG. 1 and/or base stations 420 and 430, respectively, of FIG. 4. Each of the access points 522, 524, 532, and 534 may be an embodiment of access point 130 of FIG. 1 and/or access points 422, 424, 432, and 434, respectively, of FIG. 4.

The base stations 520 and 530 and access points 522, 524, 532, and 534 collectively form the wireless network 550, and are coupled to the system controller 540 via a backhaul (not shown for simplicity). For example, each of the client devices 512 and 514 may access core network resources (e.g., the Internet) by communicating with any of the base stations and/or access points in the wireless network 550. The wireless network 550 may be subdivided into wireless sub-networks 552 and 554. For example, the first wireless sub-network 552 may be provided by base station 520 and access points 522 and 524. The second wireless sub-network 554 may be provided by base station 530 and access points 532 and 534.

As shown in FIG. 5A, the client devices 512 and 514 are within wireless range of the first wireless sub-network 552, but are outside the range of the second wireless sub-network 554. More specifically, both of the client devices 512 and 514 may be within wireless communications range of access point 524. However, in the example of FIG. 5A, client device 512 may be idle whereas client device 514 may not (e.g., client device 514 may still be transmitting Wi-Fi signals to the access point 524 or has not been idle for at least a threshold duration). In example embodiments, one or more Wi-Fi resources within the wireless network 550 may be deactivated if the Wi-Fi resources have been idle for at least a threshold duration.

Upon determining that client device 512 has been idle for at least a threshold duration, the system controller 540 may deactivate one or more Wi-Fi radios in the client device 512. For example, the system controller 540 may send a CD Wi-Fi disable (CWD) signal 541 to client device 512 via the base station 520 (e.g., as an LTE signal) or via the access point 524 (e.g., as a Wi-Fi signal). The CWD signal 541 may trigger deactivation of one or more Wi-Fi radios in a particular client device, to place the client device in a deep sleep state. For example, the CWD signal 541 may include deactivation instructions that disable the client device 512 from communicating with, or scanning for, nearby access points.

As described above with respect to FIG. 4, the client device 512 may remain connected to the wireless network 550 via an LTE (e.g., cellular) link, with a nearest base station, even after its Wi-Fi radios have been deactivated. In the example of FIG. 5A, the client device 512 may remain connected to the wireless network 550 via an LTE link with base station 520. In example embodiments, the base stations 520 and 530 of the wireless network 550 may remain active even if they are not transmitting cellular data signals to, or receiving cellular data signals from, any of the client devices 512 and/or 514. Similarly, the cellular radios in the client devices 512 and 514 may remain in an active state even if they are not transmitting cellular data signals to, or receiving cellular data signals from, any of the base stations 520 and/or 530.

In example embodiments, the system controller 540 may selectively deactivate a particular access point based at least in part on an amount of Wi-Fi activity (or inactivity) attributable to the access point. For example, the system controller 540 may deactivate a particular access point after all client devices associated with the access point have been idle (e.g., have not initiated Wi-Fi and/or LTE transmissions) for at least a threshold duration. However, the system controller 540 may refrain from deactivating a particular access point if at least one client device associated with the access point has not been idle for at least the threshold duration.

In the example of FIG. 5A, the access point 524 may still be serving at least one client device (e.g., client device 514). For example, the system controller 540 may detect the Wi-Fi activity of client device 514 based on Wi-Fi frames 542 received via the access point 524. Thus, as shown in FIG. 5A, the system controller 540 may maintain the access point 524 in an active state so that the client device 514 may continue transmitting and/or receiving Wi-Fi frames via a corresponding Wi-Fi link. The system controller 540 may deactivate the access point 524 only after both client devices 512 and 514 have been idle for at least the threshold duration.

With reference to FIG. 5B, the client 514 has become idle whereas client device 512 has become active again. Further, in the example of FIG. 5B, client device 512 has moved within wireless range of the second wireless sub-network 554 (e.g., and outside the range of the first wireless sub-network 552). More specifically, client device 512 is now within wireless communications range of access point 532. However, client device 514 is still within wireless range of the first wireless sub-network 552 (e.g., specifically within wireless communications range of access point 524).

Upon determining that client device 514 has been idle for at least a threshold duration, the system controller 540 may deactivate one or more Wi-Fi radios in the client device 514. For example, the system controller 540 may send a CWD signal 543 to client device 514 via the base station 520 (e.g., as an LTE signal) or via the access point 524 (e.g., as a Wi-Fi signal). As described above, the CWD signal 543 may trigger deactivation of one or more Wi-Fi radios in the client device 514. For example, the CWD signal 543 may include deactivation instructions that disable the client device 514 from communicating with, or scanning for, nearby access points.

As described above with respect to FIG. 4, the client device 514 may remain connected to the wireless network 550 via an LTE (e.g., cellular) link, with a nearest base station, even after its Wi-Fi radios have been deactivated. In the example of FIG. 5B, the client device 514 may remain connected to the wireless network 550 via an LTE link with base station 520. In example embodiments, the base stations 520 and 530 (e.g., and cellular radios within client device 512 and 514) may remain active even if they are not actively transmitting and/or receiving cellular data signals.

Because there are no longer any active client devices being served by the access point 524 (e.g., client device 514 is idle and client device 512 is beyond the wireless range of the access point 524), the system controller 540 may deactivate the access point 524. For example, the system controller 540 may send an AP Wi-Fi disable (AWD) signal 545 to access point 524, to place the access point 524 in a deep sleep state. For example, the AWD signal 545 may include deactivation instructions that disable the access point 524 from broadcasting beacon frames and/or responding to probe requests.

Client device 512 may re-engage the wireless network 550 by transmitting an LTE frame 544 to base station 530 via a respective LTE link. The LTE frame 544 is sent by the base station 530 to the system controller 540 (e.g., via the backhaul), which triggers activation of one or more Wi-Fi resources of the wireless network 550. In response to detecting the LTE frame 544, the system controller 540 may selectively activate one or more of the access points 522, 524, 532, and/or 534 to provide a Wi-Fi link for the client device 512. In example embodiments, the system controller 540 may select the access point that is closet to and/or provides the greatest Wi-Fi performance for the client device 512 at the time (e.g., as described above with respect to FIG. 4).

For some embodiments, the system controller 540 may activate the access point that is closest in proximity to the client device 512 (e.g., access point 532). In other embodiments, the system controller 540 may activate any access points that are within the same wireless sub-network as the client device 512 (e.g., access points 532 and 534). In the example of FIG. 5B, the system controller 540 may send an AWE signal 547 to access point, thereby enabling the access points 532 to begin broadcasting beacon frames and/or responding to probe requests.

The system controller 540 may also send a CWE signal 549 to the client device 512 via the base station 530. As described above with respect to FIG. 4, the CWE signal 549 may trigger activation of one or more Wi-Fi radios in the client device 512. For example, the CWE signal 549 may include activation instructions that enable the client device 512 to initiate communications with, or scan for, nearby access points (e.g., by broadcasting probe request frames).

For some embodiments, the AWE signal 547 and/or CWE signal 549 may indicate a predetermined Wi-Fi channel. For example, the access point 532 may be configured to operate on the predetermined Wi-Fi channel in response to the AWE signal 547. Similarly, the client device 512 may be configured to scan for the access point 532 on the predetermined Wi-Fi channel in response to the CWE signal 549.

For other embodiments, the AWE signal 547 and/or CWE signal 549 may include a network key. For example, the access point 532 may use the network key to authenticate client devices requesting to establish a Wi-Fi link with the access point 532. Similarly, the client device 512 may use the network key to authenticate with the access point 532.

Still further, for some embodiments, the system controller 540 may compare the performance of the Wi-Fi link (e.g., between client device 512 and access point 532) with that of the LTE link (e.g., between client device 512 and base station 530) to select the wireless protocol (e.g., LTE or Wi-Fi) that offers optimal performance (e.g., greater bandwidth, lower latency, higher quality of service, less interference, etc.). The system controller 540 may then instruct the client device 512 to use the selected wireless protocol for all future communications with the wireless network 550 (e.g., until one or more network conditions change).

FIG. 6 shows an example timing diagram 600 depicting selective activation and deactivation of Wi-Fi resources in a wireless network with multiple client devices. With reference to FIGS. 5A and 5B, the system controller (SC) may correspond to system controller 540, the first and second client devices (CD1 and CD2) may correspond to respective client devices 512 and 514, and the first and second access points (AP1 and AP2) may correspond to respective access points 524 and 532.

From times t₀ to t₁, both client devices CD1 and CD2 may communicate with the first access point AP1 via respective Wi-Fi links. For example, each of the client devices CD1 and CD2 may transmit Wi-Fi (WF) frames to, and receive Wi-Fi frames from, the first access point AP1. At time t₁, the first client device CD1 has stopped transmitting Wi-Fi frames to, and receiving Wi-Fi frames from, the first access point AP1.

In example embodiments, the system controller may detect a period of inactivity in communications between the first client device CD1 and the first access point AP1 based at least in part on Wi-Fi frames transmitted and/or received by AP1 (or a lack thereof). After the period of inactivity exceeds an idle threshold, from times t₁ to t₂, the system controller may send a CWD signal (CWD1) to the first client device CD1, at time t₂, to disable the first client device CD1 from transmitting and/or receiving Wi-Fi frames. For example, the CWD signal may trigger deactivation of one or more Wi-Fi radios within the first client device CD1 (e.g., by placing the Wi-Fi radios in a deep sleep state). Even with its Wi-Fi radios deactivated, the first client device CD1 may continue to maintain its connection to the wireless network via an LTE link with a base station (not shown for simplicity) in the wireless network.

In the example of FIG. 6, the second client device CD2 continues to communicate with the first access point AP1 even after the first client device CD1 has already been idle for the threshold duration. As described above, it may be desirable to allow client devices to communicate with the wireless network via Wi-Fi access points (e.g., rather than base stations) when possible. Thus, because the first access point AP1 is still serving at least one client device, the system controller may continue to maintain AP1 in an active state even after deactivating the Wi-Fi radios in the first client device at time t₂. More specifically, the system controller may allow the second client device CD2 to maintain Wi-Fi communications with the first access point AP1.

At time t₃, the second client device CD2 has stopped transmitting Wi-Fi frames to, and receiving Wi-Fi frames from, the first access point AP1. The system controller may detect a period of inactivity in communications between the second client device CD2 and the first access point AP1 based at least in part on a lack of Wi-Fi frames being transmitted and/or received by AP1. After the period of inactivity exceeds an idle threshold, from times t₃ to t₄, the system controller may send a CWD signal (CWD2) to the second client device CD2, at time t₄, to disable the second client device CD2 from transmitting and/or receiving Wi-Fi frames. Even with its Wi-Fi radios deactivated, the second client device CD2 may continue to maintain its connection to the wireless network via an LTE link with the base station (not shown for simplicity).

At time t₄, the system controller may further determine that the first access point AP1 has also been inactive for at least the idle threshold. As described above, the system controller may monitor the Wi-Fi traffic of the first access point AP1. Based on the Wi-Fi traffic (or lack thereof), the system controller may determine that the first access point AP1 is no longer serving any client devices (e.g., from times t₃ to t₄). Accordingly, the system controller may deactivate the first access point AP1 to further conserve power in the wireless network. For example, the system controller may send an AWD signal (AWD1) to the first access point AP1, at time t₄, to disable the first access point AP1 from broadcasting beacon frames and/or responding to probe requests.

At time t₅, the first client device CD1 initiates a subsequent communication with the wireless network (e.g., via the LTE link) by transmitting an LTE frame to a nearest base station (not shown for simplicity). As described above, the LTE frame may act as a trigger for reactivating one or more Wi-Fi resources in the client device and/or one or more access points in the wireless network. For example, the system controller may detect the reception of the LTE frame by a corresponding base station. In response to the LTE frame, the system controller may send a CWE signal (CWE1) to the first client device CD1, at time t₆, to re-enable the first client device CD1 to begin transmitting and/or receiving Wi-Fi frames. As described above, the CWE signal may trigger activation (or reactivation) of one or more Wi-Fi radios within the first client device CD1, for example, at time t₇.

With reference to FIG. 5B, the system controller may selectively activate an access point that is closest in proximity to the first client device CD1 and/or provides the highest quality Wi-Fi link for the first client device CD1. In the example of FIG. 6, the system controller may determine that the first client device is no longer in the vicinity of the first access point AP1 and/or is closer in proximity to the second access point AP2 (e.g., than it is to the first access point AP1). Accordingly, the system controller may activate the second access point AP2 to provide a Wi-Fi link with which the first client device CD1 may access the wireless network. Specifically, the system controller may send an AWE signal (AWE2) to the second access point AP2, at time t₆, to enable the second access point AP2 to begin broadcasting beacon frames and/or responding to probe requests, for example, at time t₇.

For some embodiments, the AWE signal and/or CWE signal may indicate a predetermined Wi-Fi channel (e.g., on which the second access point AP2 is to operate and the first client device CD1 is to scan). For other embodiments, the AWE signal and/or CWE signal may include a network key (e.g., for authenticating the first client device CD1 with the second access point AP2). In some aspects, the first client device CD1 may scan for the second access point AP2, for example, by broadcasting probe requests (e.g., and listening for probe responses) and/or listening for beacons from the second access point AP2. The first client device may then establish a Wi-Fi link with the second access point AP2, for example, by exchanging authentication frames, association frames, and performing a 4-way handshake (e.g., as described above with respect to FIG. 2A).

FIG. 7 shows a system controller 700 for a wireless communications system in accordance with example embodiments. The system controller 700 may be an embodiment of system controller 152 of FIG. 1, system controller 440 of FIG. 4, and/or system controller 540 of FIGS. 5A-5B. The system controller 700 includes at least a backhaul interface 710, a processor 720, and a memory 730. The backhaul interface 710 includes a cellular interface 712 and a Wi-Fi interface 714. The cellular interface 712 may be coupled to one or more base stations via a first set of wired and/or wireless backhaul connections (not shown for simplicity). The Wi-Fi interface 714 may be coupled to one or more access points via a second set of wired and/or wireless backhaul connections (not shown for simplicity).

Processor 720, which is coupled to the backhaul interface 710 and memory 730, may be any suitable one or more processors capable of executing scripts or instructions of one or more software programs stored in the system controller 700 (e.g., within memory 730). For purposes of discussion herein, processor 720 is shown in FIG. 7 as being coupled between the backhaul interface 710 and memory 730. For actual embodiments, the backhaul interface 710, processor 720, and/or memory 730 may be connected together using one or more buses (not shown for simplicity).

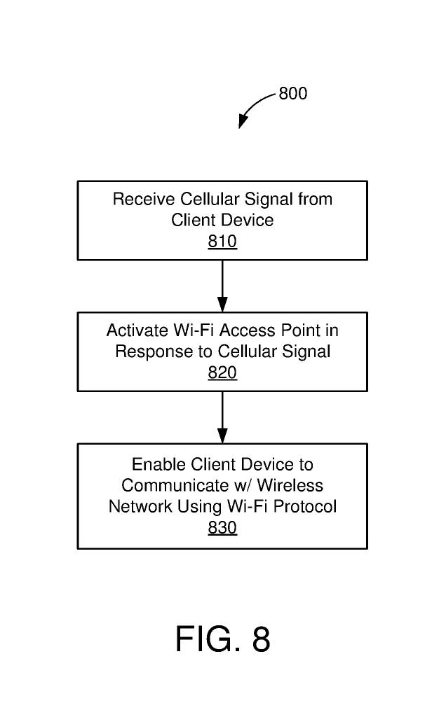

Memory 730 may include a non-transitory computer-readable medium (e.g., one or more nonvolatile memory elements, such as EPROM, EEPROM, Flash memory, a hard drive, etc.) that may store the following software modules:
a client device (CD) detection module 731 to detect when a client device attempts to initiate a wireless communication with a base station coupled to the system controller 700;
an access point (AP) selection module 733 to select one or more access points, coupled to the system controller 700, that are closest to and/or within wireless range of the detected client device;
a Wi-Fi activation module 735 to activate Wi-Fi resources on the detected client device and/or selected access point(s);
a Wi-Fi handoff module 737 to selectively hand off communications with the client device from the base station to the selected access point(s) based at least in part on a performance comparison of the Wi-Fi link relative to the LTE link; and
a Wi-Fi deactivation module 739 to deactivate the Wi-Fi resources on the detected client device and/or selected access point(s) when the Wi-Fi link is not in use.
   Each software module includes instructions that, when executed by processor 720, cause system controller 700 to perform the corresponding functions. The non-transitory computer-readable medium of memory 730 thus includes instructions for performing all or a portion of the operations depicted in FIGS. 8-11.

For example, processor 720 may execute the CD detection module 731 to detect when a client device attempts to initiate a wireless communication with a base station coupled to the system controller 700. Processor 720 may also execute the AP selection module 733 to select one or more access points, coupled to the system controller 700, that are closest to and/or within wireless range of the detected client device. Further, processor 720 may execute the Wi-Fi activation module 735 to activate Wi-Fi resources on the detected client device and/or selected access point(s). Still further, processor 720 may execute the Wi-Fi handoff module 737 to selectively hand off communication with the client device from the base station to the selected access point(s) based at least in part on a performance comparison of the Wi-Fi link relative to the LTE link.

Processor 720 may activate the Wi-Fi deactivation module 739 to deactivate the Wi-Fi resources on the detected client device and/or selected access point(s) when the Wi-Fi link is not in use (e.g., or is idle for at least a threshold duration). In some aspects, the Wi-Fi deactivation module 739, as executed by processor 720, may deactivate a particular access point only if the access point (e.g., and any client devices served by the access point) has been idle for at least the threshold duration. In other aspects, the Wi-Fi deactivation module 739, as executed by processor 720, may not deactivate a particular access point if at least one client device associated with the access point has not been idle for at least the threshold duration.

FIG. 8 shows a flowchart depicting an example operation 800 for activating Wi-Fi resources in a wireless network in response to a cellular communications signal. With reference, for example, to FIG. 1, the example operation 800 may be performed by the system controller 152 to selectively enable Wi-Fi communications between the client device 110 and access point 130.

The system controller 152 first receives a cellular signal from the client device 110 (810). In example embodiments, the LTE link 112 between the client device 110 and the base station 120 is always active (e.g., LTE radios in the respective devices are in an active state). Thus, the client device 110 may transmit an LTE signal (e.g., corresponding to a data frame) to the base station 120 via the LTE link 112. The base station 120 may then forward the LTE frame to the system controller 152 via the backhaul 150.

The system controller 152 then activates the Wi-Fi access point 130 in response to the cellular signal (820). In example embodiments, the Wi-Fi link 113 between the client device 110 and access point 130 is initially deactivated (e.g., Wi-Fi radios in the client device 110 and access point 130 are in a deep sleep state). Thus, the client device 110 is initially prevented from scanning for nearby access points (e.g., by broadcasting probe request frames), and the access point 130 is prevented from broadcasting beacon frames. Upon detecting the LTE frame, the system controller 152 may restore the access point 130 (e.g., or one or more Wi-Fi radios of the access point 130) to an active state. This enables the access point 130 to begin broadcasting beacon frames.

Finally, the system controller 152 enables the client device 110 to communicate with the wireless network 140 using the Wi-Fi protocol (830). For example, upon detecting the LTE frame, the system controller 152 may restore the Wi-Fi radios of the client device 110 to an active state. This enables the client device 110 to begin scanning for access points (e.g., by broadcasting probe request frames). Once the client device 110 discovers the access point 130 (or vice-versa), a Wi-Fi link 113 may be established between the client device 110 and access point 130. The system controller 152 may then enable subsequent and/or ongoing communications between the client device 110 and the wireless network 140 to be routed through the access point 130 (e.g., in lieu of the base station 120).

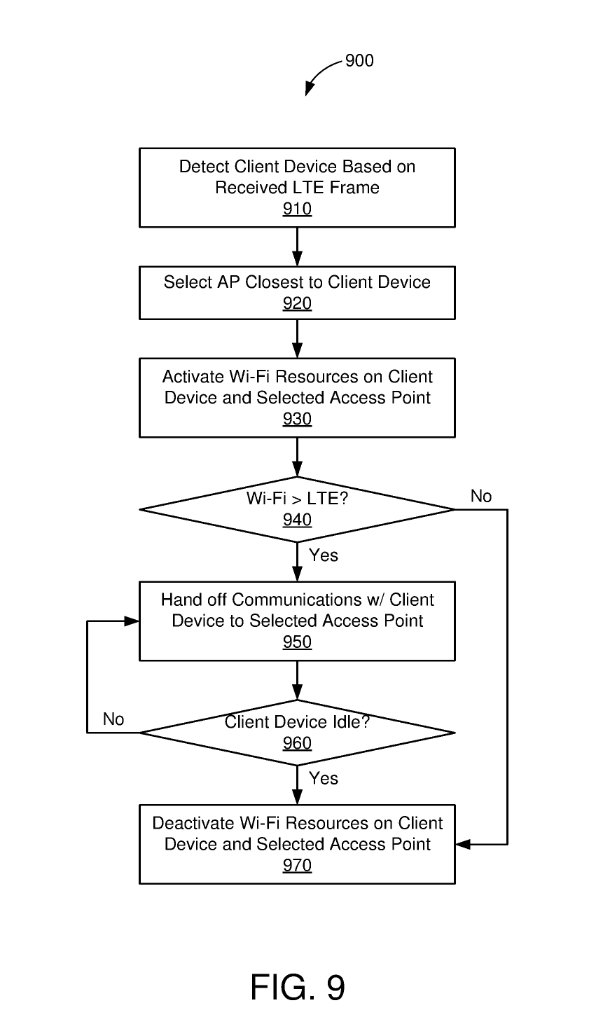

FIG. 9 shows a flowchart depicting an example operation 900 for controlling an activation and deactivation of Wi-Fi resources in a wireless network. With reference, for example, to FIG. 4, the example operation 900 may be performed by the system controller 440 to selectively enable and/or disable Wi-Fi communications between the client device 110 and an access point in the wireless network 450.

The system controller 440 detects a client device 410 based on a received LTE frame (910). In example embodiments, any communications between the client device 410 and the wireless communications system 400 are initiated over an LTE link between the client device 410 and a respective base station in the wireless network 450. Moreover, the client device 110 may be actively connected to the wireless network 450 via an LTE link as long as the client device 410 is within wireless range of at least one of the base stations 420 and/or 430 of the wireless network 450. Thus, the client device 410 may initiate a communication with the wireless network 450 by transmitting an LTE frame 442 to base station 420. The base station may then forward the LTE frame 442 to the system controller 440 (e.g., one or more backhaul connections).

The system controller 440 then selects an access point closest in proximity to the client device 410 (920). For example, the system controller 440 may detect that the client device 410 is within the first wireless sub-network 452 because the LTE frame was received by base station 420. Further, the system controller 440 may detect a more accurate location of the client device 410 based at least in part on RSSI data, base station triangulation, GPS data, and/or other geolocation information provided by the client device 410 and/or base station 420. Based on the location of the client device 410, the system controller 440 may select access point 424 as the access point closest in proximity to the client device 410.

Wi-Fi resources on the client device 410 and the selected access point 424 are activated in response to the LTE frame (930). In example embodiments, the Wi-Fi radios in the client device 410 and access points 422, 424, 432, and 434 are initially deactivated (e.g., placed in a deep sleep state). Upon detecting the LTE frame 442, the system controller 440 may send respective Wi-Fi enable signals 444 and 446 to the client device 410 (e.g., by way of the base station 420) and access point 424. The Wi-Fi enable signals 444 and 446 cause the Wi-Fi radios in the client device 410 and access point 422, respectively, to return to an active state. More specifically, the CWE signal 446 enables the client device 410 to begin scanning for nearby access points (e.g., by broadcasting probe request frames), and the AWE signal 444 enables the access point 424 to begin broadcasting beacon frames. For some embodiments, the Wi-Fi enable signals 444 and 446 may include matching configuration information (e.g., wireless channel and/or network key information) to facilitate the establishment of a Wi-Fi connection between the client device 410 and the access point 424.

The system controller 440 may compare the performance of the Wi-Fi link (e.g., between the client device 410 and access point 424) with the performance of the LTE link (e.g., between the client device 410 and base station 420) to determine whether to continue communicating with the client device 410 via the LTE link or to hand off communications to the Wi-Fi link (940). For example, if the performance of the LTE link is superior to the performance of the Wi-Fi link (as tested at 940), the system controller 440 may allow the client device 410 to continue communicating with the wireless network 450 by way of the base station only. Accordingly, the system controller 440 may proceed to deactivate the Wi-Fi resources on the client device 410 and the selected access point 424 (970).

If the performance of the Wi-Fi link is superior to the performance of the LTE link (as tested at 940), the system controller 440 may hand off communications with the client device 410 to the selected access point 424 (950). For example, the system controller 440 may instruct the base station 420 to hand off subsequent and/or ongoing communications with the client device 410 to the access point 424 (e.g., as described above with reference to FIG. 3). Thus, as long as the Wi-Fi resources of the client device 410 and access point 424 remain active, any communications between the client device 410 and the wireless communications system 400 are subsequently routed through access point 424 (e.g., in lieu of base station 420).

The system controller 440 may monitor the activity on the Wi-Fi link (e.g., between the client device 410 and access point 424) to determine whether the client device 410 has been idle for a threshold duration (960). As long as the idle threshold has not been reached (as tested at 960), the system controller 440 may allow the Wi-Fi resources on the client device 410 and access point 424 to remain active. For example, the client device 410 may scan for nearby access points (e.g., by broadcasting probe request frames), and the access point 424 may broadcast beacon frames.

If the client device 410 has been idle for at least the threshold duration (as tested at 960), the system controller 440 may subsequently deactivate the Wi-Fi resources on the client device 410 and access point 424 (970). For example, respective Wi-Fi radios on the client device 410 and access point 424 may return to the deep sleep state (e.g., powered on but prevented from transmitting and/or receiving Wi-Fi signals). Accordingly, the client device 410 may be prevented from broadcasting probe request frames, and the access point 424 may be prevented from broadcasting beacon frames.

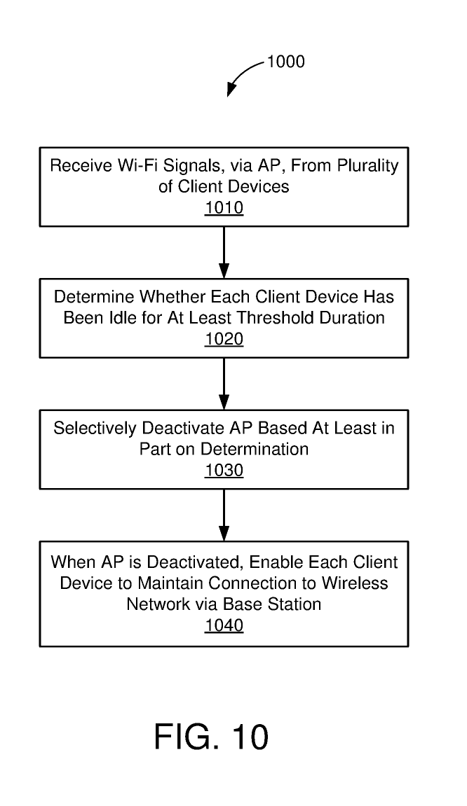

FIG. 10 shows a flowchart depicting an example operation 1000 for selectively deactivating Wi-Fi resources in a wireless network including a plurality of client devices. With reference, for example, to FIGS. 5A and 5B, the example operation 1000 may be performed by the system controller 540 to selectively disable an access point (e.g., access point 524) from broadcasting beacon frames in the wireless network 550.

The system controller 540 may receive Wi-Fi signals, via the access point, from a plurality of client devices (1010). In example embodiments, the system controller 540 may monitor the Wi-Fi activity of a particular access point to detect the client devices being served by, and/or in communication with, the particular access point. More specifically, the system controller 540 may monitor Wi-Fi signals (e.g., Wi-Fi frames 542) received by a particular access point to determine whether the access point is currently serving, and/or in communication with, the one or more client devices.

The system controller 540 may then determine whether each of the client devices has been idle for at least a threshold duration (1020). For example, with reference to FIG. 5A, client devices 512 and 514 may both be within wireless communications range of access point 524 at a given time. However, client device 512 may be idle whereas client device 514 may not (e.g., client device 514 may still be transmitting Wi-Fi signals to the access point 524 or has not been idle for at least the threshold duration). The system controller 540 may determine that client device 514 is still active based on the Wi-Fi frames 542 received from the client device 514, via the access point 524. On the other hand, the system controller 540 may determine that client device 512 is idle based on the lack of Wi-Fi activity from the client device 512.

The system controller 540 may then selectively deactivate the access point based at least in part on the determination (1030). In example embodiments, the system controller 540 may deactivate a particular access point after all client devices associated with the access point have been idle (e.g., have not initiated Wi-Fi and/or LTE transmissions) for at least a threshold duration. However, the system controller 540 may maintain the access point in an active state if at least one client device associated with the access point has not been idle for at least the threshold duration.

In the example of FIG. 5A, the system controller 540 may refrain from deactivating access point 524 since the access point 524 may still be serving at least one client device (e.g., client device 514). For example, the system controller 540 may maintain the access point 524 in an active state so that the client device 514 may continue transmitting and/or receiving Wi-Fi frames via a corresponding Wi-Fi link. In the example of FIG. 5B, the system controller may deactivate access point 524 since the access point 524 is no longer serving any client devices (e.g., client device 514 has been idle for at least a threshold duration, whereas client device 512 is no longer within communications range of the access point 524). For example, the system controller 540 may send an AWD signal 545 to the access point 524, to place the access point 524 in a deep sleep state.

When the access point is deactivated, the system controller 540 may enable each client device associated with the access point to maintain a respective connection to the wireless network via a base station (1040). In example embodiments, the base stations of a wireless network may remain active even if they are not transmitting cellular data signals to, or receiving cellular data signals from, any client devices. Similarly, the cellular radios in a client device may remain in an active state even if they are not transmitting cellular data signals to, or receiving cellular data signals from, any base stations. This allows the client device to remain connected to at least one base station of the wireless network (e.g., as long as the client device is within wireless range of one or more base stations).

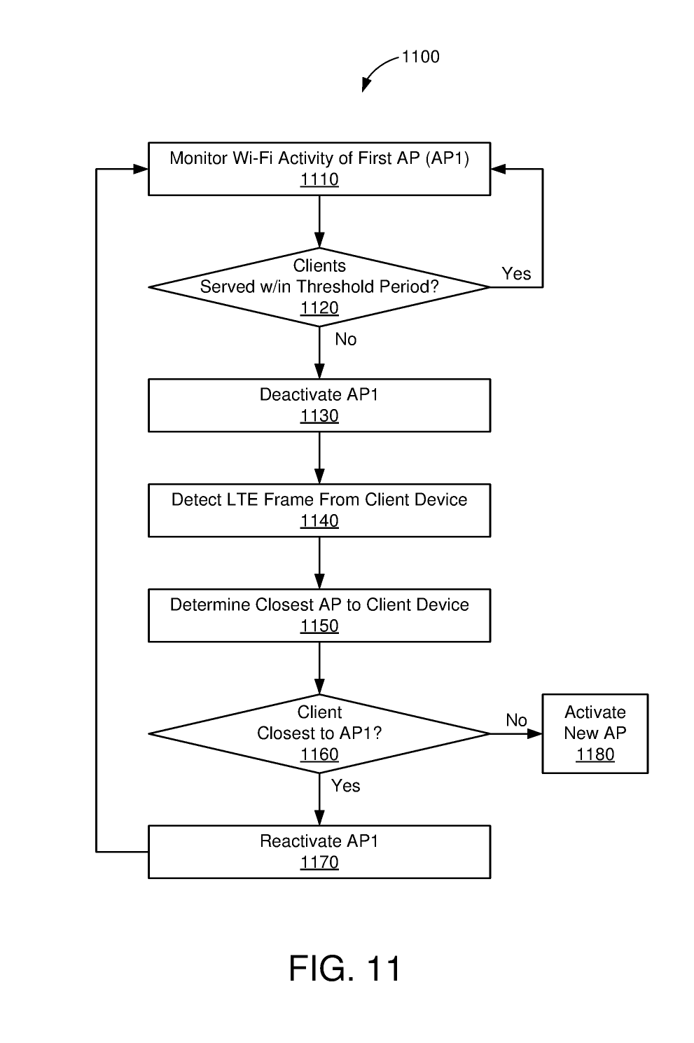

FIG. 11 shows a flowchart depicting an example operation 1100 for controlling activation and deactivation of a particular Wi-Fi access point. With reference, for example, to FIGS. 5A and 5B, the example operation 1100 may be performed by the system controller 540 to selectively enable and/or disable an access point (e.g., access point 524) from broadcasting beacon frames in the wireless network 550.

The system controller 540 may monitor the Wi-Fi activity of a first access point (AP1) in the wireless network (1110). In example embodiments, the system controller 540 may monitor the Wi-Fi activity of a particular access point to detect the client devices being served by, and/or in communication with, the particular access point. More specifically, the system controller 540 may monitor Wi-Fi signals received by a particular access point to determine whether the access point is currently serving, and/or in communication with, the one or more client devices.

The system controller 540 may then determine whether the first access point has served any client devices within a threshold period (1120). More specifically, an access point my serve a client device by transmitting Wi-Fi frames to, or receiving Wi-Fi frames from, the particular client device (e.g., not including beacon frames that are broadcast to any devices in the vicinity of the access point). As long as the first access point is serving at least one client device (as tested at 1120), the system controller 540 may allow the first access point to remain in an active state while continuing to monitor the Wi-Fi activity of the first access point (1110).

If the first access point has not served any client devices within the threshold period (as tested at 1120), the system controller 540 may then deactivate the first access point (1130). The system controller 540 may deactivate the first access point by disabling or preventing the first access point from broadcasting beacon frames (e.g., while continuing to maintain a Wi-Fi link with any associated client devices). For example, the system controller 540 may send an AWD signal to the first access point, to place the access point in a deep sleep state.

The system controller 540 may subsequently detect an LTE frame from a client device (1140). For example, the system controller 540 may receive the LTE frame from the client device via a base station in the wireless network. In example embodiments, the LTE frame may act as a trigger for activating or reactivating one or more Wi-Fi resources in the wireless network (e.g., including access points and/or Wi-Fi radios within client devices).

In response to the LTE frame, the system controller 540 may determine the closest access point to the client device (1150). As described above, the system controller 540 may determine a relative location of the client device (e.g., in the wireless network) based on received signal strength indicator (RSSI) values, base station triangulation, global positioning satellite (GPS) data, and other ranging and/or geolocation information. The system controller 540 may also have predetermined knowledge of the locations of the access points in the wireless network.

In example embodiments, the system controller 540 may selectively activate an access point that is closest in proximity to the client device. Specifically, the system controller 540 may determine whether the client device is closest to the first access point (1160). If the client device is closest to the first access point (as tested at 1160), the system controller 540 may reactivate the first access point (1170). Assuming a W-Fi link between the client device and the first access point was previously established (e.g., and both devices were simply in a deep-sleep state), the client device and first access point may begin exchanging Wi-Fi data frames immediately upon reactivation of the first access point (e.g., without repeating the authentication, association, and/or handshake processes).

If the client device is closer to another access point (as tested at 1160), the system controller 540 may activate a new access point to provide the Wi-Fi link for the client device (1180). Upon activating the new access point, the system controller 540 may facilitate an authentication, association, and/or handshake process between the new access point and the client device. For example, the system controller 540 may communicate Wi-Fi channel information, to the client device and the new access point (e.g., via CWE and AWE signals, respectively), specifying a predetermined Wi-Fi channel on which new access point is to operate. Further, the system controller 540 may communicate a network key, to the client device and the new access point (e.g., via CWE and AWE signals, respectively), to be used for authenticating the client device to the new access point.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific examples. It will, however, be evident that various modifications and changes may be made thereto without departing from the broader scope of the disclosure as set forth in the appended claims. For example, the method steps depicted in the flow charts of FIGS. 6 and 7 may be performed in other suitable orders, multiple steps may be combined into a single step, and/or some steps may be omitted (or further steps included). The specification and drawings are, accordingly, to be regarded in an illustrative sense rather than a restrictive sense.

What is claimed is:

1. A method of operating a wireless network including at least a first access point (AP) and a base station, the method comprising:
receiving Wi-Fi signals, via the first AP, from a plurality of client devices connected to the wireless network;
determining whether each of the plurality of client devices has been idle for at least a threshold duration;
selectively deactivating the first AP based at least in part on the determination; and
when the first AP is deactivated, enabling each of the plurality of client devices to maintain its connection to the wireless network via the base station.

2. The method of claim 1, wherein the selectively deactivating comprises:
disabling the first AP from broadcasting beacons if each of the plurality of client devices has been idle for at least the threshold duration.

3. The method of claim 1, wherein the selectively deactivating comprises:
maintaining the first AP in an active state if at least one of the plurality of client devices has not been idle for at least the threshold duration.

4. The method of claim 1, further comprising:
triggering deactivation of a Wi-Fi radio in at least one of the plurality of client devices upon determining that the at least one of the plurality of client devices has been idle for at least the threshold duration.

5. The method of claim 4, wherein the triggering comprises:
disabling the client device from communicating with, or scanning for, one or more access points.

6. The method of claim 1, further comprising:
receiving a cellular signal from at least one of the plurality of client devices while the first AP is deactivated;
reactivating the first AP in response to the cellular signal; and
enabling the at least one of the plurality of client devices to communicate with the wireless network via the first AP.

7. The method of claim 1, further comprising:
receiving a cellular signal from at least one of the plurality of client devices while the first AP is deactivated;
activating a second AP in response to the cellular signal; and
enabling the at least one of the plurality of client devices to communicate with the wireless network via the second AP.

8. The method of claim 7, wherein the activating of the second AP comprises:
determining that the at least one of the plurality of client devices is closer in proximity to the second AP than to the first AP.

9. The method of claim 7, wherein the enabling of the at least one of the plurality of client devices to communicate via the second AP comprises:
triggering activation of a Wi-Fi radio in the at least one of the plurality of client devices; and
enabling the at least one of the plurality of client devices to associate with the second AP using the Wi-Fi radio.

10. The method of claim 7, wherein the enabling of the at least one of the plurality of client devices to associate with the second AP comprises:
communicating a network key to the at least one of the plurality of client devices; and
communicating the network key to the second AP, wherein the network key is to authenticate the at least one of the plurality of client devices with the second AP.

11. A system controller for a wireless network, the system controller comprising:
one or more processors; and
a memory storing instructions that, when executed by the one or more processors, cause the system controller to:
receive Wi-Fi signals, via a first access point (AP), from a plurality of client devices connected to the wireless network;
determine whether each of the plurality of client devices has been idle for at least a threshold duration;
selectively deactivate the first AP based at least in part on the determination; and
when the first AP is deactivated, enable each of the plurality of client devices to maintain its connection to the wireless network via a base station.

12. The system controller of claim 11, wherein execution of the instructions to selectively deactivate the first AP causes the system controller to:
disable the first AP from broadcasting beacons if each of the plurality of client devices has been idle for at least the threshold duration.

13. The system controller of claim 11, wherein execution of the instructions to selectively deactivate the first AP causes the system controller to:
maintain the first AP in an active state if at least one of the plurality of client devices has not been idle for at least the threshold duration.

14. The system controller of claim 11, wherein execution of the instructions further causes the system controller to:
trigger deactivation of a Wi-Fi radio in at least one of the plurality of client devices upon determining that the at least one of the plurality of client devices has been idle for at least the threshold duration, wherein the deactivation of the Wi-Fi radio disables the client device from communicating with, or scanning for, one or more access points.

15. The system controller of claim 11, wherein execution of the instructions further causes the system controller to:
receive a cellular signal from at least one of the plurality of client devices while the first AP is deactivated;
reactivate the first AP in response to the cellular signal; and
enable the at least one of the plurality of client devices to communicate with the wireless network via the first AP.

16. The system controller of claim 11, wherein execution of the instructions further causes the system controller to:
receive a cellular signal from at least one of the plurality of client devices while the first AP is deactivated;
activate a second AP in response to the cellular signal; and
enable the at least one of the plurality of client devices to communicate with the wireless network via the second AP.

17. The system controller of claim 16, wherein execution of the instructions to activate the second AP causes the system controller to:
determine that the at least one of the plurality of client devices is closer in proximity to the second AP than to the first AP.

18. The system controller of claim 16, wherein execution of the instructions to enable the at least one of the plurality of client devices to communicate via the second AP causes the system controller to:
communicate a network key to the at least one of the plurality of client devices; and
communicate the network key to the second AP, wherein the network key is to authenticate the at least one of the plurality of client devices with the second AP.

19. A system controller for a wireless network, the system controller comprising:
means for receiving Wi-Fi signals, via a first access point (AP), from a plurality of client devices connected to the wireless network;
means for determining whether each of the plurality of client devices has been idle for at least a threshold duration;
means for selectively deactivating the first AP based at least in part on the determination; and
means for enabling each of the plurality of client devices to maintain its connection to the wireless network via a base station when the first AP is deactivated.

20. The system controller of claim 19, wherein the means for selectively deactivating the first AP is to:
disable the first AP from broadcasting beacons if each of the plurality of client devices has been idle for at least the threshold duration.

21. The system controller of claim 19, wherein the means for selectively deactivating the first AP is to:
maintain the first AP in an activate state if at least one of the plurality of client devices has not been idle for at least the threshold duration.

22. The system controller of claim 19, further comprising:
means for triggering deactivation of a Wi-Fi radio in at least one of the plurality of client devices upon determining that the at least one of the plurality of client devices has been idle for at least the threshold duration, wherein the deactivation of the Wi-Fi radio disables the client device from communicating with, or scanning for, one or more access points.

23. The system controller of claim 19, further comprising:
means for receiving a cellular signal from at least one of the plurality of client devices while the first AP is deactivated;
means for reactivating the first AP in response to the cellular signal; and
means for enabling the at least one of the plurality of client devices to communicate with the wireless network via the first AP.

24. The system controller of claim 19, further comprising:
means for receiving a cellular signal from at least one of the plurality of client devices while the first AP is deactivated;
means for activating a second AP in response to the cellular signal; and
means for enabling the at least one of the plurality of client devices to communicate with the wireless network via the second AP.

25. The system controller of claim 24, wherein the means for activating the second AP is to:
determine that the at least one of the plurality of client devices is closer in proximity to the second AP than to the first AP.

26. The system controller of claim 24, wherein the means for enabling the at least one of the plurality of client devices to communicate via the second AP is to:
communicate a network key to the at least one of the plurality of client devices; and
communicate the network key to the second AP, wherein the network key is to authenticate the at least one of the plurality of client devices with the second AP.

27. A non-transitory computer-readable medium storing program instructions that, when executed by a processor of a system controller for a wireless network, causes the system controller to:
receive Wi-Fi signals, via a first access point (AP), from a plurality of client devices connected to the wireless network;
determine whether each of the plurality of client devices has been idle for at least a threshold duration;
selectively deactivate the first AP based at least in part on the determination; and
when the first AP is deactivated, enable each of the plurality of client devices to maintain its connection to the wireless network via a base station.

28. The non-transitory computer-readable medium of claim 27, wherein execution of the instructions to selectively deactivate the first AP causes the system controller to:
disable the first AP from broadcasting beacons if each of the plurality of client devices has been idle for at least the threshold duration.

29. The non-transitory computer-readable medium of claim 27, wherein execution of the instructions to selectively deactivate the first AP causes the system controller to:
maintain the first AP in an active state if at least one of the plurality of client devices has not been idle for at least the threshold duration.

30. The non-transitory computer-readable medium of claim 27, wherein execution of the instructions further causes the system controller to:
receive a cellular signal from at least one of the plurality of client devices while the first AP is deactivated;
in response to the cellular signal, determine that the at least one of the plurality of client devices is closer in proximity to a second AP than to the first AP;
activate the second AP based on the determination; and
enable the at least one of the plurality of client devices to communicate with the wireless network via the second AP.
